(19) United States
(12) Patent Application Publication
(10) Pub. No.: US 2011/0189578 A1
(43) Pub. Date: Aug. 4, 2011

(54) FUEL CELL SYSTEM INCLUDING A RESILIENT MANIFOLD INTERCONNECTING MEMBER

(75) Inventors: Aaron T. Crumm, Ann Arbor, MI (US); Timothy LaBreche, Ann Arbor, MI (US)

(73) Assignee: ADAPTIVE MATERIALS, INC., Ann Arbor, MI (US)

(21) Appl. No.: 12/698,035

(22) Filed: Feb. 1, 2010

(51) Int. Cl. H01M 8/04; H01M 8/24

(52) U.S. Cl. 429/461

(57) ABSTRACT

A solid oxide fuel cell module includes a manifold member comprising a plurality of openings. The solid oxide fuel cell module further includes a plurality of fuel cell tube units. The solid oxide fuel cell module further includes a fuel cell tube unit to manifold interconnect member providing a fluid flow channel between the manifold member and the plurality of tubes, wherein the fuel cell tube unit to manifold interconnect member comprises a polymer material.

### RELATED APPLICATIONS

The present application claims priority to U.S. Provisional Application No. 61/206,483, which is hereby incorporated by reference herein in its entirety.

### GOVERNMENT INTERESTS

This invention was made with government support under contract number W909MY-08-C-0025, awarded by the Department of Defense. The government has certain rights in this invention.

### FIELD OF THE INVENTION

The invention relates to fuel cells and with more particularity to manifolds for fuel cell systems.

### BACKGROUND OF THE INVENTION

Manifolds are used to route and distribute air and fuel into various components of a fuel cell system. Current fuel cell systems utilize manifolds that are rigidly coupled to the fuel cell tubes. Therefore, current manifold designs are not adapted for portable applications in that current manifold designs are undesirably large, are not designed for mass manufacturability, and are not robust, shock, vibration, and thermal transitions.

For example, current manifolds do not allow fuel cell components to flex or comply to allow for variations in the position of fuel cell tubes relative to each other or relative to other fuel cell components. Further, rigid manifold connections do not allow for variations in fuel cell components for example structural variations, shape, straightness, or other toleranced dimensions that can vary during manufacturing. Rigid manifolds can restrict the packaging design and manufacturing options and can undesirably increase the overall size of portable fuel cells. Still further, current manifolds are not adapted for portability and current manifolds are not configured to manage thermal expansion differences between component materials. Therefore, there is a need for a fuel cell manifold that is compliant and that allows variations in the position of fuel cell tubes relative to each other and relative to other fuel cell components.

### BRIEF DESCRIPTION OF THE DRAWINGS

FIG. 1 is a plan view of one embodiment of a fuel cell system including a manifold member in accordance with an exemplary embodiment of the present disclosure;

FIG. 2 is a side view and

FIG. 3 is a sectional view of the manifold member coupled to a plurality of fuel cell tubes of the fuel cell system of FIG. 1;

FIG. 4 is a perspective view of a fuel cell system including a manifold member in accordance with another embodiment of the present disclosure;

FIG. 5 is a plan view of the manifold of FIG. 4 with a lid removed detailing the plurality of outlets;

FIG. 6 is a plan view of the lid of FIG. 5;

FIG. 7 is a side view of a interconnecting member including a backpressure control member of the fuel cell system of FIG. 4;

FIG. 8 is a partial view of an end of a fuel cell system having a plurality of fuel cell tubes;

FIG. 9 is a partial perspective view of the manifold member connected to the plurality of fuel cell tubes of FIG. 4;

FIG. 10 is a partial sectional view showing one embodiment of a manifold member coupled to a fuel cell tubes;

FIG. 11 is a partial sectional view showing one embodiment of a compliant manifold coupled to a fuel cell tube;

FIG. 12 is a partial sectional view showing one embodiment of a compliant manifold having steps that engage and locate the reactor and fuel cell tube; and

FIG. 13 is a prospective view of a fuel cell tube.

### SUMMARY

A solid oxide fuel cell module includes a manifold member comprising a plurality of openings. The solid oxide fuel cell module further includes a plurality of fuel cell tube units. The solid oxide fuel cell module further includes a fuel cell tube unit to manifold interconnect member providing a fluid flow channel between the manifold member and the plurality of tubes, wherein the fuel cell tube unit to manifold interconnect member comprises a polymer material.

### DETAILED DESCRIPTION

Fuel cell systems in accordance with exemplary embodiments are described herein. In one embodiment, a manifold member distributes gas to multiple fuel cell tubes of the fuel cell system. The manifold member is connected to each of the fuel cell tubes such that a substantially gas-tight seal is maintained between an inner chamber of each fuel cell tube and an inner chamber of the manifold member. In one embodiment, a resilient interconnecting member couples the manifold to the fuel cell tubes. The resilient member allows for movement of the plurality of fuel cell tubes connected to the manifold member relative to other fuel cell components. The resilient member can dampen oscillations and reduce mechanical stresses on components of the fuel cell system due to movement of fuel cell components relative to each other. Movement of fuel cell components relative to each other can be caused by external forces on the fuel cell system (for example, vibrational movement), by thermal expansion mismatch between fuel cell system components and by fluid flow within the fuel cell system. Further, the resilient member can adapt to manufacturing variations in, for example, tube size and tube position and the resilient member can facilitate simplified manifold-to-tube assembly.

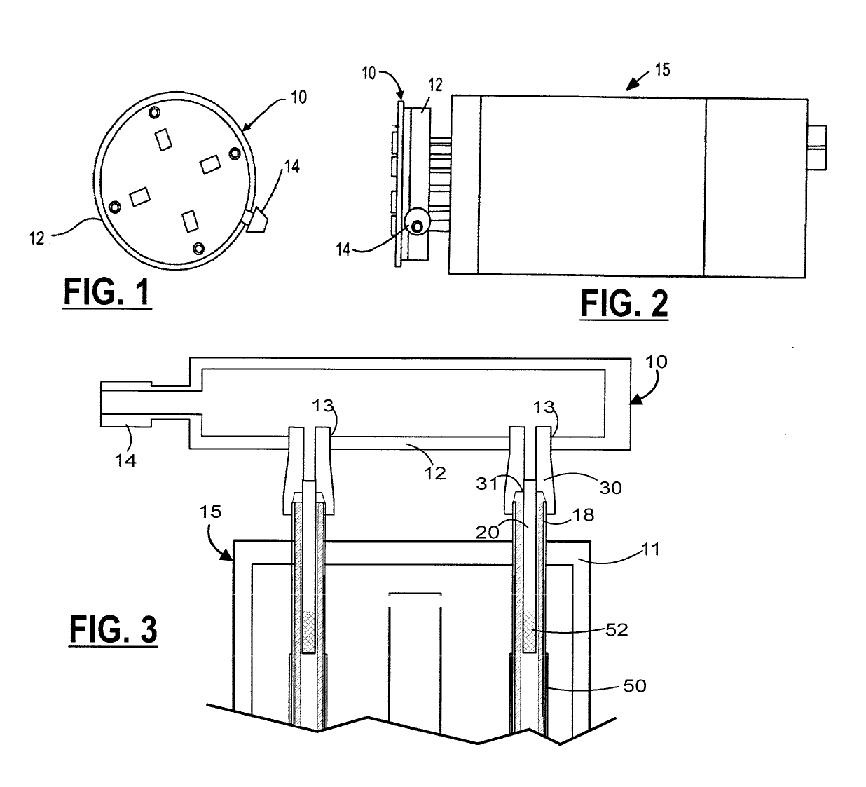

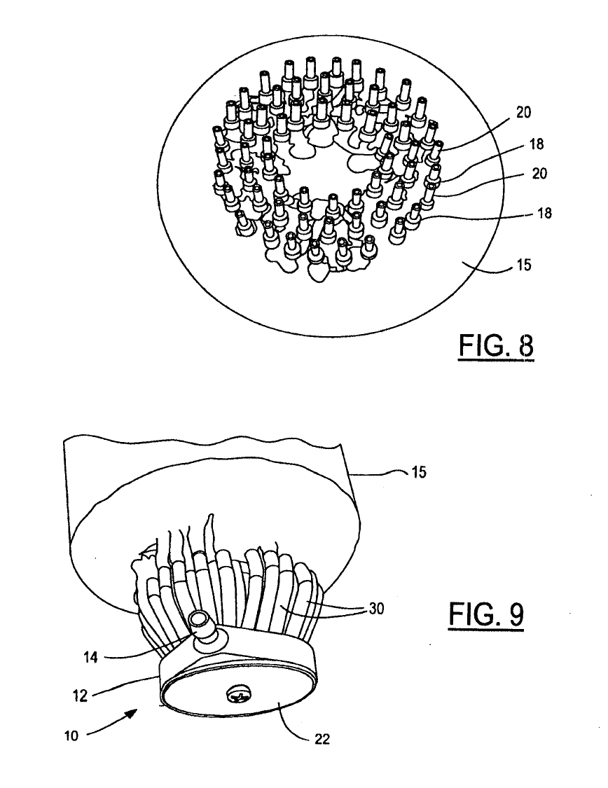

FIGS. 1-13 generally depict a fuel cell system 15. Referring to FIGS. 3 and 13, the fuel cell system 15 includes a fuel feed tube 20 and a fuel cell tube 18. The fuel cell tubes extend in thermally insulated walls 11. The fuel cell tube 18 and the fuel feed tube 20 together are a fuel cell tube unit 21. The fuel feed tube 20 is disposed within an inlet portion 17 of the fuel cell tube 18. Unreformed fuel enters an inlet portion 19 of the fuel feed tube 20. The unreformed fuel is routed through the fuel feed tube 20 to an internal fuel reformer 52 where the fuel is reformed and the resulting reformed fuel is heated during the exothermic reformation reactions (for an exemplary fuel cell system having an internal fuel reformer, see U.S. Pat. No. 7,547,484 entitled SOLID OXIDE FUEL CELL WITH INTERNAL FUEL PROCESSING which is hereby incorporated by reference in its entirety. The fuel reformation reaction occurs downstream from the inlet portion 19 of the fuel cell tube 18.

The fuel cell tubes 18 each comprises an anode layer, an electrolyte layer, and a cathode layer at an active portion 50 that generates electromotive force at the active portion 50 at operating temperatures in the range of 600 to 950 degrees Celsius. However, only the active portion 50 of the fuel cell tube 18 contains the anode layer, the electrolyte layer, and the cathode layer, and therefore, only a portion of the fuel cell tube 18 requires high operating temperatures for generating electromotive force. Therefore, the operating temperatures proximate the inlet portion 19 of the fuel cell tube 20 is less than 250 degrees Celsius, and in an exemplary embodiment, the operating temperature proximate the inlet portion 19 of the fuel cell tube 20 is between about 100 degrees Celsius and 250 degrees Celsius. Thus, low-temperature materials such as the flexible materials described for the interconnect member 30 be utilized to couple the fuel cell tubes 18 to the manifold member 10.

The exemplary fuel cell tube 18 is a solid oxide fuel cell that is advantageously relatively lightweight and that can operate providing high power to mass ratio. As an example, the tube can be 1 mm-30 mm in diameter and can be heated rapidly. An example of a suitable fuel cell is disclosed in U.S. Pat. No. 6,749,799 to Crumm et al, entitled METHOD FOR PREPARATION OF SOLID STATE ELECTROCHEMICAL DEVICE which is hereby incorporated by reference in its entirety. Other material combinations for the anode layer, the cathode layer, and the electrolyte layer as well as other cross-section geometries (triangular, square, polygonal, etc.) will be readily apparent to those skilled in the art given the benefit of the disclosure.

The manifold member 10 can input fuel in one or more inlet openings and substantially evenly distribute fuel among multiple fuel cell tubes 18 of the fuel cell system 15. The manifold member 10 can distribute fuel substantially evenly utilizing backpressure control members. Referring to FIG. 7, in one embodiment, the backpressure control member 26 is disposed at a fuel inlet end of an interconnecting member 30 and has an orifice with a selected cross-sectional area to create a predetermined amount of backpressure to substantially evenly distribute fuel to each of the fuel cell tubes 18. In one embodiment, backpressure control members are disposed within the plurality of fuel cell tubes. The cross-sectional area can be calibrated to create a selected amount of backpressure to regulate fuel flow from the manifold member 10 into each of the fuel cell tubes 18 of the fuel cell system 15. The amount of backpressure desired for a specific backpressure control member can vary based on, for example, the travel path of fuel within the fuel cell system, the number of fuel cell tubes, and the width and length of the fuel cell tubes.

In one embodiment, the backpressure control member can provide functionality in addition to providing a calibrated cross-sectional area for creating a selected amount of backpressure. For example, in one embodiment, a current collector (not shown) disposed within the fuel cell tube 18 can have a calibrated cross-sectional area providing pneumatic resistance to create a selected amount of backpressure. Additionally, in another aspect, the backpressure control members may be integral with the fuel cell tubes 18, that is, the fuel cell tubes 18 may have a calibrated cross-sectional area to provide a selected amount of pneumatic resistance.

The back pressure control member can reduce variability due to downstream pneumatic pressure thereby providing substantially uniforms fuel flow through each of the fuel cell tubes. For example, a fuel cell stack can operate at a nominal operating pressure of 2+/−0.5 inches (or a 25% variance range) without a back pressure control member. Back pressure control members tolerance to provide a 5+/−0.05 inches of back pressure can be added to the fuel cell stack with the nominal operating pressure of 2+/−0.5 inches thereby providing a fuel cell with a back pressure of 7+/−0.55 inches (or a 7.9% variance range).

In one embodiment, the fuel reforming reactor 52 disposed within the fuel cell tube 18 can have a calibrated cross-sectional area to create a selected amount of backpressure. In one embodiment, the backpressure control member can comprise multiple components within the fuel cell tube. For example, a fuel reforming reactor disposed within a fuel feed tube and a current collector can each have calibrated cross sectional areas to create a selected amount of backpressure such that the fuel is substantially evenly distributed among the fuel cell tubes.

Referring to FIGS. 1-3, the manifold member 10 includes a manifold head 12 having an inlet 14 and a plurality of outlets 16. The manifold member 10 comprises interconnecting members 30 to maintain gas-tights seals between an inner chamber of the manifold member 10 and an inner chamber each of the fuel cell tubes 18. In one embodiment, the manifold member 10 may be utilized for coupling a plurality of fuel cell tubes 18 of the fuel cell system 15 to a fuel source such that the input of fuel into each of the plurality of fuel cell tubes 18 is substantially balanced. As shown in FIG. 3, the plurality of fuel cell tubes 18 are received in and sealed relative to the plurality of outlets 16 of the manifold head 12. In this manner, fuel introduced into the manifold member 10 passes to the plurality of fuel cell tubes 18 without escaping into an ambient portion of the fuel cell system 15. In one aspect, and as shown in FIG. 3, the plurality of fuel cell tubes 18 may be connected with the plurality of fuel feed tubes 20 that are inserted into and gas-tight coupled with the plurality of fuel cell tubes 18. By integrating steps into the region of the manifold that is associated with the fuel cell tube, the fuel feed tubes and/or similar structures, the manifold member is further able to provide a support and provide a substantially gas tight fit between the manifold and each of the tubes to avoid leaking.

In one embodiment, the interconnecting members 30 comprise a flexible silicone-base polymer configured maintain a gas tight seal with the end of the fuel cell tube at temperatures above 100 degrees Celsius and more specifically temperatures of about 200 degrees Celsius to about 250 degrees Celsius. Other exemplary materials for interconnect members are described below:

TABLE 1
Young's Elasticity Modulus

| Material | Gpa |
|---|---|
| Rubber | 0.01-0.1 |
| LD Polyethylene | 0.2 |
| HD Polyethylene | 0.8 |
| Polystyrene | 1.5-2 |
| Nylon | 3 |
| Graphite | 1.5 |
| Cork | 0.03 |
| Polycarbonate | 0.7 |
| Polyurathane Elastomer | 0.25 |
| Silicone Polymer | 0.01-0.1 |

Table 1 includes exemplary interconnecting member 30 material and associated Young's Elasticity Moduli for each material including rubber, low density (‘LD’) polyethylene, high density (“HD”) polyethylene, nylone, graphite, cork, polycarbonate, polyurethane elastomer, and silicone polymers. Other exemplary materials can further include other elastomers, natural rubber and synthetic rubber (e.g., nytrol), natural latex and synthetic latex (vinyl acetate, styrene-butadiene, and acrylates). The exemplary interconnect members can comprise a modulus of elasticity that is less than or equal to one tenth a modulus of elasticity of a portion of the fuel cell tube unit 21 contacting the manifold member. In one embodiment, the polymer material comprises an elastic modulus of less than 3 GPA, and more specifically less than 0.8 GPA. In one embodiment, the interconnect member comprises material having and elastic modulus of less than 0.1 GPA, for example silicone-based polymers, rubber and like materials.

The fuel cell manifold member 10 may have various shapes including, for example, a ring shape or a disc shape as shown in the figures. For example, the fuel cell tubes 18 may be positioned in any of a number of configuration including tube rays, tube bundles, and individual tubes. Further, it should be realized that various shapes and positions of the outlets 16 may be utilized. For example, the outlets 16 may be arranged in various patterns and formations to direct fuel to fuel cell tubes 18 configured in various positions.

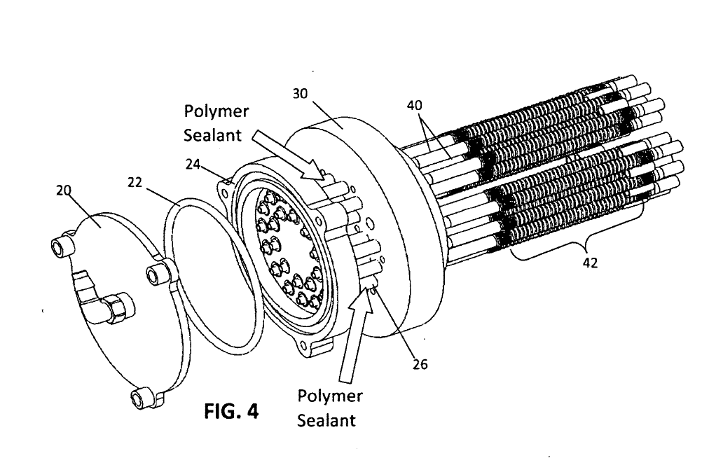

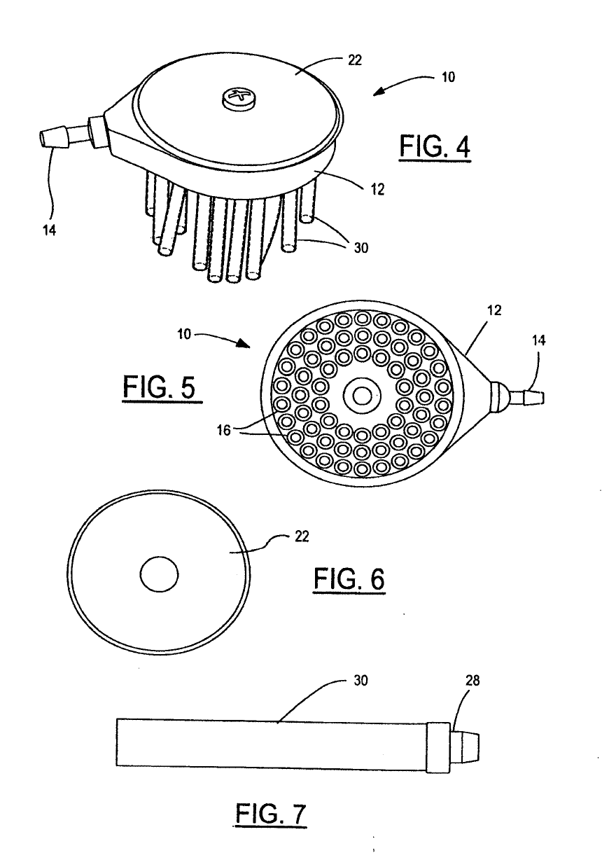

Referring to FIG. 4, in another aspect, a lid 22 may be removably connected to a top of the manifold head 12 to allow access into an interior of the manifold member 10 to simplify manufacturing through coupling of the manifold member 10 to a fuel cell as well as allow for replacement of various components of the fuel cell system. The manifold member 10 may also include an external circuit board (not shown) that may be attached to a top of the manifold head 12.

The manifold member 10 may also include an active cooling mechanism associated with the manifold to regulate a temperature of the manifold. Various active cooling mechanisms including fans and blowers may be utilized to maintain a temperature range of the manifold 10.

Referring to FIGS. 4-9, there is shown a second embodiment of a manifold member 10. The second embodiment of the manifold member 10 may include a plurality of interconnecting members 30 coupled in each of the plurality of outlets 16 and connected with the plurality of fuel cell tubes 18. The plurality of interconnecting members 30 are flexible or “mechanically compliant” The term “mechanically compliant” as used herein, refers to the ability of the manifold member 10 to move relative to the plurality of fuel cell tubes 18 such that shocks and movements associated with the manifold member 10 may be absorbed by the interconnecting members 30. As with the previously described embodiment, the manifold member 10 may include backpressure control members 28, shown in FIG. 7 associated with each of the interconnecting members 30 for balancing the fuel flow into the plurality of fuel cell tubes 18. The backpressure control members 28 may include a precision orifice or a precision orifice packaged in a cartridge, as well as a flow restrictor that is a capillary tube.

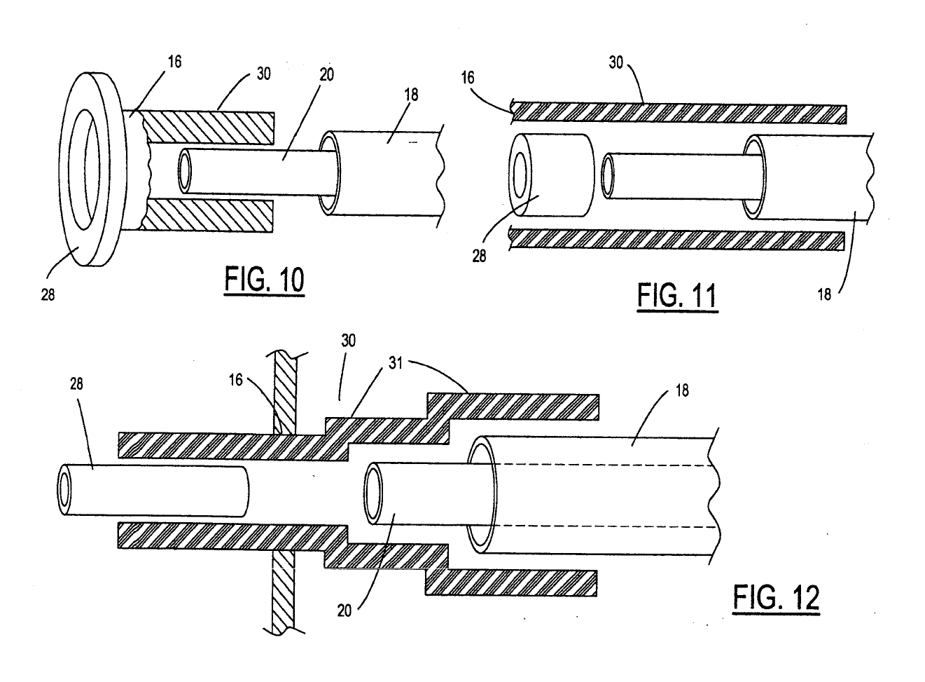

Referring to FIGS. 10-11 there are shown various structures of the plurality of interconnecting members 30. In the depicted embodiment of FIG. 10, the interconnecting member 30 is connected to the outlet member 16 and to the fuel feed tube 20. In the embodiment depicted in FIG. 12, the interconnecting member 30 is connected to the outlet member 16 and to the fuel cell tube 18. A backpressure control member 28, such as a precision orifice, may also be positioned within the interconnecting member 30. In the embodiment depicted in FIG. 12, the interconnecting member 30 includes stepped portions 31 to locate the fuel cell tube 18 and fuel feed tube 20. In this manner the fuel feed tube 20 may be positioned longitudinally and radially with respect to the fuel cell tube 18. It should be realized that the interconnecting member 30 may include various numbers of stepped portions 31. For example, one of the steps shown in FIG. 11 may be removed such that either the fuel cell tube 18 or fuel feed tube 20 is positioned longitudinally with respect to the outlet member 16. Alternatively, the step portions may allow the fuel cell tube or similar structure can to be integrated directly into the manifold member. Although the exemplary tube is shown in which both external and internal diameters are stepped in alternate embodiment, the tube can have an a continuously decreasing internal diameter, a stepped in diameter with a constant outer diameter, a lip or shoulder or other features to facilitate substantially gas tight connections with the fuel cell tubes and the fuel feed tubes.

The manifold member 10 as described above has a compact shape and design that allows for positioning of a manifold member 10 closely to the fuel cell tubes 18 and allows for the mounting of circuit boards 24 outside of a hot zone of the fuel cell system 15. Additionally, the fuel cell system 15 provides passive fuel distribution and flow control such that a substantially similar amount of fuel is routed to each of the fuel cell tubes 18.

Further, the manifold member 10 also provides a mechanically compliant manifold member 10 allowing variations in the position of the manifold member 10 relative to the fuel cell tubes 18. The fuel cell system 15 includes internal reformers 52 that heat fuel inside the fuel cell tubes 18, thereby allowing a low-temperature seal between the fuel cell tubes and the manifold member 10.

The invention has been described in an illustrative manner. It is to be understood that the terminology which has been used is intended to be in the nature of words of description, rather than limitation. Many modifications and variations of the invention are possible in light of the above teachings. Therefore, within the scope of the appended claims, the invention may be practiced other than as specifically described.

1. A solid oxide fuel cell module comprising:
a manifold member comprising a plurality of openings;
a plurality of fuel cell tube units; and
a fuel cell tube unit to manifold interconnect member providing a fluid flow channel between the manifold member and the plurality of tubes, wherein the fuel cell tube unit to manifold interconnect member comprises a polymer material.

2. The solid oxide fuel cell module of claim 1, wherein the polymer material comprises a modulus of elasticity that is less than or equal to one tenth a modulus of elasticity of a portion of the fuel cell tube unit contacting the manifold member.

3. The solid oxide fuel cell module of claim 1, wherein the polymer material comprises an elastic modulus of less than 3 GPA.

4. The solid oxide fuel cell module of claim 1, wherein the polymer material comprises an elastic modulus of less than 0.8 GPA.

5. The solid oxide fuel cell module of claim 1, wherein the polymer material comprises an elastic modulus of less than 0.1 GPA.

6. The solid oxide fuel cell module of claim 1, wherein the polymer material comprises a silicone-based polymer.

7. The solid oxide fuel cell module of claim 1, wherein the polymer material is configured to provide a substantially gas tight flow path to an inlet end of the fuel cell tube, wherein the fuel cell tube inlet end of the fuel cell tube having an operating temperature in the range of 100 degrees Celsius to 250 degrees Celsius.

8. The solid oxide fuel cell module of claim 1, wherein the polymer material comprises one of polyethylene and rubber.

9. The solid oxide fuel module of claim 1, further comprising:
thermally insulated walls defining an insulated chamber, the thermally insulated walls having a plurality openings disposed therethrough, the fuel cell tubes extending through openings of the insulated walls.

10. The solid oxide fuel cell module of claim 8, the fuel cell module is substantially gas tight sealed between insulated chamber and outer walls of the fuel cell tubes.

11. The solid oxide fuel cell module of claim 8, wherein the connecting member resiliently couples the fuel cell tubes to the manifold member to dampen forces between the fuel cell tubes and the thermally insulated walls.

12. The solid oxide fuel cell module of claim 8, wherein the interconnecting member radially resilient such that the interconnect member form as gas tight seal with the fuel cell tube.

12. The solid oxide fuel cell module of claim 1, wherein the fuel cell tube unit comprises a fuel cell tube and wherein the interconnecting member is connected to the outer circumference of the fuel cell tube.

13. The solid oxide fuel cell module of claim 1, wherein the fuel cell tube unit comprises a fuel cell tube and a fuel feed tube.

14. The solid oxide fuel cell module of claim 1, wherein the fuel cell tube unit forms a substantially fluid impermeable seal between the fuel cell tube and the interconnecting member.

15. The solid oxide fuel cell module of claim 14, wherein the fuel cell tube unit forms a first substantially fluid impermeable seal between the fuel cell tube and the interconnecting member and a second substantially fluid impermeable seal between the fuel feed tube and the interconnecting member.

16. The solid oxide fuel cell module of claim 15, wherein the interconnecting member comprises a stepped inner diameter.

17. The solid oxide fuel cell module of claim 15, wherein the interconnecting member is disposed through the openings of the manifold member.

18. A solid oxide fuel cell module comprising:
a manifold member comprising a plurality of openings;
a plurality of fuel cell tube units; and
a fuel cell tube unit to manifold interconnect member providing a fluid flow channel between the manifold member and the plurality of tubes, wherein the polymer material comprises a modulus of elasticity that is less than or equal to one tenth a modulus of elasticity of a portion of the fuel cell tube unit contacting the manifold member.

19. The solid oxide fuel cell module of claim 18, wherein the modulus of elasticity of the portion of the fuel cell tube contacting the manifold member is less than 0.8 GPA.

20. The solid oxide fuel cell of claim 18, wherein the interconnect material comprises at least one of a natural rubber, a synthetic rubber, and silicone-based polymer.
